(19) United States
(12) Patent Application Publication
(10) Pub. No.: US 2023/0175872 A1
(43) Pub. Date: Jun. 8, 2023

(54) INPUT DEVICE AND CONTROL METHOD THEREOF

(71) Applicant: Chicony Electronics Co., Ltd., New Taipei City (TW)

(72) Inventors: Chien-Tsung CHEN, New Taipei City (TW); Shih-Hao LU, New Taipei City (TW)

(21) Appl. No.: 17/808,546

(22) Filed: Jun. 24, 2022

(30) Foreign Application Priority Data
Dec. 6, 2021 (TW) 110145541

(51) Int. Cl. G01D 5/244; G06F 3/038; G06F 3/0362; G01D 5/249

(52) U.S. Cl. CPC G01D 5/24495; G06F 3/038; G06F 3/0362; G01D 5/2497

(57) ABSTRACT

The present disclosure provides an input device and control method thereof. The input device includes a roller module, a relative encoder, an absolute encoder, and a processor. The control method includes: obtaining current angle data outputted by the absolute encoder according to a target phase of at least one signal outputted by the relative encoder; obtaining a current position number corresponding to the current angle data according to the current angle data; calculating a number difference according to the current position number and a previous position number; and outputting the number difference.

### CROSS-REFERENCE TO RELATED APPLICATION

This application claims priority to Taiwan Application Serial Number 110145541, filed Dec. 6, 2021, which is herein incorporated by reference in its entirety.

### BACKGROUND

### Field of Invention

This disclosure relates to the input device and control method thereof, and in particular to the input device, which has the relative encoder and the absolute encoder, and control method thereof.

### Description of Related Art

There are two kinds of rotary encoder in current mouse: relative encoder (e.g., mechanical rotary encoder or optical rotary encoder) and absolute encoder (e.g., magnetic rotary encoder).

The relative encoder often abnormally outputs due to mechanical damage and dust accumulation. Therefore, the service life of the mouse which adapts the relative encoder is usually short.

The absolute encoder often occurs output error due to the mismatch between the magnetic field and Hall device. Therefore, the absolute encoder needs to be calibrated according to the motion of the mouse's roller before leaving factory generally. However, if there is a problem (for example, incorrect magnetic induction due to temperature change, mechanical structure damaged due to drop of the mouse) after the absolute encoder leaves factory, the mouse cannot be normally used because it is unable to calibrate the absolute encoder again.

### SUMMARY

An aspect of present disclosure relates to a control method of an input device. The control method includes: obtaining current angle data outputted by an absolute encoder according to a target phase of at least one signal outputted by a relative encoder; obtaining a current position number corresponding to the current angle data according to the current angle data; calculating a number difference according to the current position number and a previous position number; and outputting the number difference.

Another aspect of present disclosure relates to a control method of an input device. The control method includes: obtaining first angle data and second angle data outputted by an absolute encoder according to two adjacent target phases of at least one signal outputted by a relative encoder; if a difference value between the first angle data and the second angle data is smaller than or equal to a predetermined angle value, using the first angle data or the second angle data as current angle data; obtaining a current position number corresponding to the current angle data according to the current angle data; calculating a number difference according to the current position number and a previous position number; and outputting the number difference.

Another aspect of present disclosure relates to an input device. The input device is coupled to a computer device, wherein the computer device is configured to display a displayed screen, and the input device includes a roller module, a relative encoder, an absolute encoder, and a processor. The roller module is configured to generate a motion in response to a user operation. The relative encoder is configured to generate at least one signal according to the motion of the roller module. The absolute encoder is configured to output a rotation angle of the roller module with respect to a reference position according to the motion of the roller module. The processor is configured to execute following steps: obtaining current angle data outputted by an absolute encoder when the at least one signal is in a target phase; obtaining a current position number corresponding to the current angle data according to the current angle data; calculating a number difference according to the current position number and a previous position number; and outputting the number difference.

### BRIEF DESCRIPTION OF THE DRAWINGS

FIG. 1 is block diagram of an input device in accordance with some embodiments of the present disclosure;

FIG. 2 is a flow diagram of a control method of the input device in accordance with some embodiments of the present disclosure;

FIG. 3 is a schematic diagram of normal signals outputted by relative encoder in accordance with some embodiments of the present disclosure;

FIG. 4 is a flow diagram of a control method of the input device in accordance with some embodiments of the present disclosure; and

FIG. 5 is a schematic diagram of abnormal signals outputted by relative encoder in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

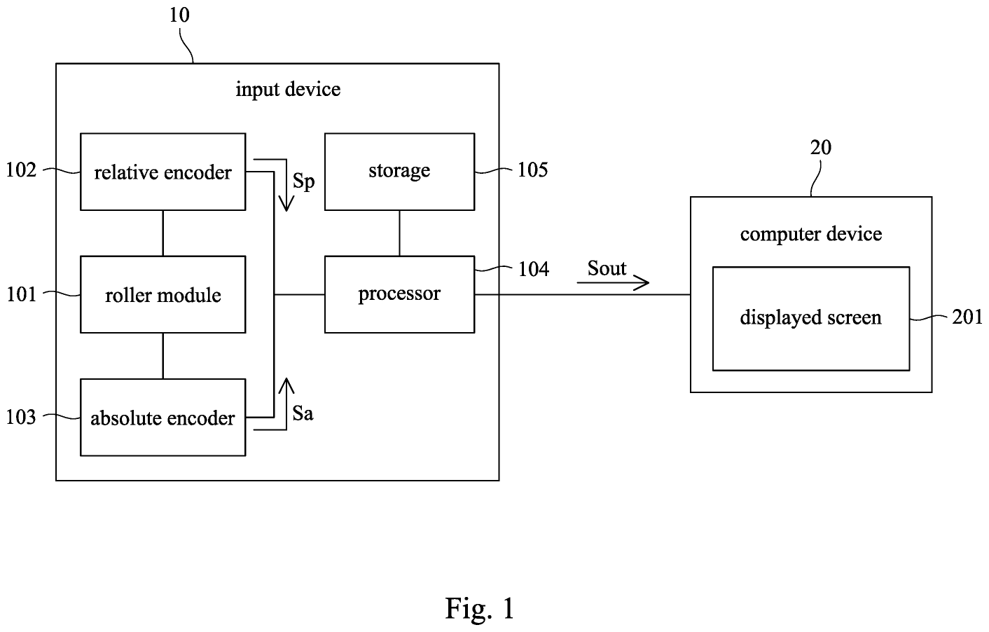

Referring to FIG. 1, FIG. 1 is a block diagram of an input device 10 in accordance with some embodiments of the present disclosure. In some practical applications, the input device 10 is coupled to a computer device 20 and is configured to generate an output signal Sout to the computer device 20 in response to a user operation (e.g., moving the input device 10, clicking or pressing a key on the input device 10, rolling a roller of the input device 10, etc.) so that the computer device 20 controls a displayed screen 201, which is displayed by the computer device 20, according to the output signal Sout. It can be appreciated that the input device 10 can be implemented by human machine interface device having roller (e.g., mouse, game controller, etc.), and the computer device 20 can be, for example but not limited to, desktop computer, laptop computer, or tablet.

As shown in FIG. 1, the input device 10 includes a roller module 101, a relative encoder 102, an absolute encoder 103, a processor 104 and a storage 105. In structure, the relative encoder 102 and the absolute encoder 103 are disposed on the roller module 101. The processor 104 is coupled to the relative encoder 102, the absolute encoder 103 and the storage 105 and is configured to be coupled to the computer device 20.

In some embodiments, the relative encoder 102 can be implemented by mechanical rotary encoder or optical rotary encoder. The absolute encoder 103 can be implemented by magnetic rotary encoder. The processor 104 can be implemented by one or more central processing unit (CPU), application-specific integrated circuit (ASIC), microprocessor, system on a Chip (SoC) or other suitable processing units. The storage 105 can be implemented by memory.

It can be appreciated that the roller module 101 can generate a motion (e.g., rotation) in response to the user operation. When generating the motion, the roller module 101 would drive the relative encoder 102 and the absolute encoder 103 to act synchronously. In such way, the relative encoder 102 can generate at least one signal Sp according to the motion of the roller module 101, and the absolute encoder 103 can output a rotation angle Sa according to the motion of the roller module 101. In some embodiments, the rotation angle Sa is an angle at which the roller module 101 rotates around an axle center with respect to a reference position (for example, a position that the roller module 101 has not been rotated). In other words, the rotation angle Sa is a kind of absolute information.

In some embodiments, the storage 105 can store a lookup list. Referring to Table 1, Table 1 depicts a lookup list in accordance with some embodiments of the present disclosure. In particular, the lookup list includes a plurality of angle values Va and a plurality of position numbers Np corresponding to the angle values Va. Each of the position number Np is corresponding to a specific position of the roller module 101. For example, the number (1) represents that the roller module 101 is at the aforementioned reference position, thereby corresponding to the angle of 0°. It can be appreciated that the numerical values in Table 1 are only for descriptive purpose and are not used to limit the present disclosure.

TABLE 1

| Np | (1) | (2) | (3) | (4) | (5) | (6) | (7) | (8) |
|---|---|---|---|---|---|---|---|---|
| Va | 0° | 15° | 30° | 45° | 60° | 75° | 90° | 105° |
| Np | (9) | (10) | (11) | (12) | (13) | (14) | (15) | (16) |
| Va | 120° | 135° | 150° | 165° | 180° | 195° | 210° | 225° |
| Np | (17) | (18) | (19) | (20) | (21) | (22) | (23) | (24) |
| Va | 240° | 255° | 270° | 285° | 300° | 315° | 330° | 345° |

In some embodiments, the signal Sp outputted by the relative encoder 102 has multiple different phases (which would be described in detail later). The phases of the signal Sp include at least one target phase (which would be described in detail later), and the target phase is configured to trigger the processor 104 to perform related operations. In particular, the processor 104 can obtain the rotation angle Sa currently outputted by the absolute encoder 103 when the signal Sp is in the target phase. Then, the processor 104 can find the position number Np (which would be described in detail later) corresponding to the currently outputted rotation angle Sa by the lookup list (e.g., Table 1) stored in the storage 105 and can generate a number difference as the output signal Sout according to the currently found position number Np and the previously found position number Np, so as to output the output signal Sout to the computer device 20. It can be appreciated that the number difference can be positive or negative integer. In some practical applications, the computer device 20 controls a page of a window in the displayed screen 201 to scroll upwards or downwards according to the positive or negative integer.

In some embodiments, when the relative encoder 102 normally operates, the absolute encoder 103 might output incorrect rotation angle Sa due to the influence of the magnetic field and Hall device. In other words, there might be error in the rotation angle Sa. In view of this, the processor 104 can calculate an angle difference according to the currently outputted rotation angle Sa and the angle value Va corresponding to the currently found position number Np and can determine whether or not the angle difference is smaller than or equal to an error range (e.g., ±3°). In addition, the processor 104 can further selectively update the angle value Va corresponding to the currently found position number Np according to the determination result, so as to solve the error problem of the rotation angle Sa.

In some embodiments, the relative encoder 102 would output abnormal signal Sp due to the influence of mechanical damage or dusts (that is, the relative encoder 102 abnormally operates), which results in the processor 104 reading the output of the absolute encoder 103 at the wrong time. In particular, since a time difference between two adjacent target phases of the abnormal signal Sp might be too small, two rotation angles Sa that the processor 104 obtains according to the two adjacent target phases might be close. In other words, a difference value between the two rotation angles Sa might be smaller than normal value. In view of this, the processor 104 can determine whether or not the difference value between the two rotation angles Sa obtained according to the two adjacent target phases is smaller than or equal to a predetermined angle value (for example 10°). If the determination result shows that the difference value between the two rotation angles Sa is smaller than or equal to the predetermined angle value, the processor 104 can further perform related operations (which would be described in detail later) to avoid performing calculation based on wrong information.

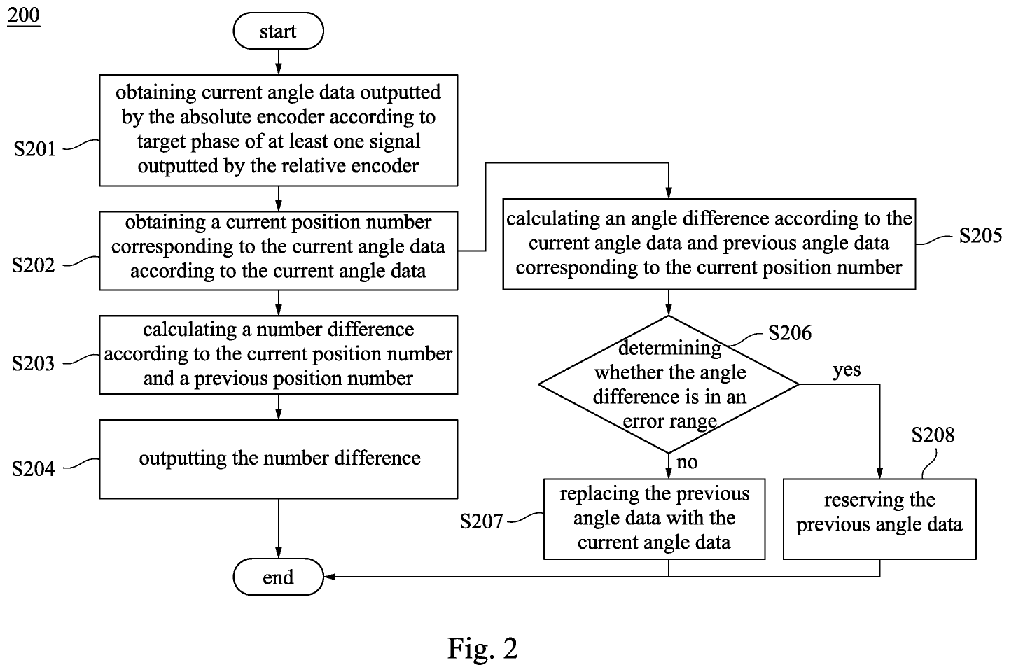

The operation of the input device 10 when the relative encoder 102 normally operates is described below with reference to FIG. 2. Referring to FIG. 2, FIG. 2 is a flow diagram of a control method 200 in accordance with some embodiments of the present disclosure. The control method 200 can be executed by the input device 10 of FIG. 1, but the present disclosure is not limited herein. In some embodiments, the control method 200 includes steps S201-S208.

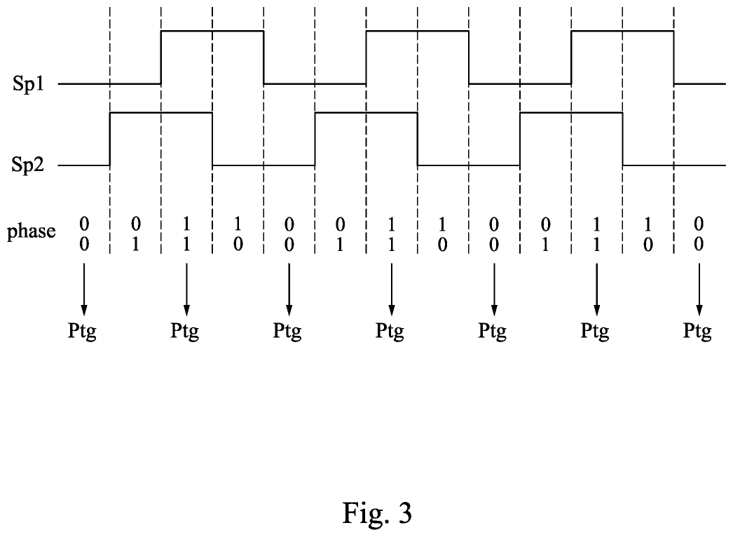

In step S201, current angle data outputted by the absolute encoder is obtained according to the target phase of at least one signal outputted by the relative encoder. Referring to FIG. 3 together, FIG. 3 is a schematic diagram of the at least one signal outputted by the relative encoder 102, which normally operates, in accordance with some embodiments of the present disclosure. In some embodiments, the at least one signal includes a first signal Sp1 and a second signal Sp2 which are different from each other. According to the combination of the voltage level of the first signal Sp1 and the voltage level of the second signal Sp2, the at least one signal includes four different phases (i.e., the multiple phases of the signal Sp), for example phases “00”, “01”, “11” and “10” in FIG. 3. It can be appreciated that “0” in FIG. 3 represents a low voltage level, and “1” in FIG. 3 represents a high voltage level. The combination that the voltage level of the first signal Sp1 is same as the voltage level of the second signal Sp2 is regarded as a target phase Ptg, for example the phases “00” and “11” in FIG. 3. The processor 104 would read the rotation angle Sa outputted by the absolute encoder 103 as the current angle data when the at least one signal (i.e., the first signal Sp1 and the second signal Sp2) is in the target phase Ptg.

In step S202, a current position number corresponding to the current angle data is obtained according to the current angle data. In some embodiments, the processor 104 can obtain the current position number corresponding to the current angle data by the lookup list. For example, the current angle data is 37°. The processor 104 would compare the current angle data with multiple angle values Va in the lookup list to find one angle value Va (e.g., 30°) closest to the current angle data. Then, the processor 104 obtains the number (3) corresponding to the angle value Va of 30° as the current position number. For another example, the current angle data is 67.5°. The angle value Va closest to 67.5° in the lookup list might be 60° or 75°. At this time, the processor 104 is further configured to determine the angle value Va closest to 67.5° to be 60° or 75° according to a determination trend of the processor 104 when obtaining the position numbers corresponding to previous sets of angle data. It is assumed that a previous angle data is 37° and the processor 104 determines the angle value Va closet to the previous angle data in the lookup list to be 30°. Since last time the processor 104 chooses the angle value Va which is smaller than the angle data outputted by the absolute encoder 103, the processor 104 this time would also choose the angle value Va (i.e., 60°) which is smaller than the current angle data and would regard the number (5) corresponding to the angle value Va of 60° in the lookup list as the current position number.

In step S203, a number difference is calculated according to the current position number and a previous position number. It can be appreciated that the previous position number is the current positon number that the processor 104 obtains last time and can be stored in the storage 105. For example, the current position number that the processor 104 obtains last time is the number (5). The processor 104 would subtract “5” (i.e., the previous position number) from “3” (i.e., the current position number), so as to calculate that the number difference is “−2”.

In step S204, the number difference is outputted. In some embodiments, as shown in FIG. 1, the processor 104 outputs the number difference as the output signal Sout to the computer device 20 for the computer device 20 to control the displayed screen 201.

As shown in FIG. 2, after step S202, the processor 104 further performs step S205 to calibrate the output error of the absolute encoder 103. In step S205, an angle difference is calculated according to the current angle data and a previous angle data corresponding to the current position number. In some embodiment, the previous angle data is the angle value Va that the current position number is corresponding in the lookup list. The description is made by taking the above-described example, the previous angle data is 30°. The processor 104 subtracts the previous angle data of 30° from the current angle data of 37° to calculate that the angle difference is 7°.

In step S206, it is determined whether the angle difference is in an error range. In some embodiments, the error range is ±3°. The description is made by taking the above-described example, since the angle difference of 7° is greater than 3°, the processor 104 determines that the angle difference exceeds the error range. Since the angle difference exceeds the error range, the processor 104 performs step S207.

In step S207, the previous angle data is replaced with the current angle data. The description is made by taking the above-described example, the processor 104 updates the angle value Va corresponding to the current position number (e.g., the number (3)) in the lookup list from 30° (i.e., the previous angle data) to 37° (i.e., the current angle data).

In another example, the processor 104 determines that the angle difference does not exceed the error range, and thereby performing step S208. In step S208, the previous angle data is reserved. For example, the processor 104 would not update the angle value Va in the lookup list, so that the angle value Va corresponding to the current position number (e.g., the number (3)) in the lookup list is still 30° (i.e., the previous angle data). In other embodiments, step S208 is omitted. In other words, after determining the angle difference does not exceed the error range, the processor 104 can perform no operation.

It can be seen from the description of the control method 200 that in the condition that the relative encoder 102 normally operates, the input device 10 not only can accurately generate the output signal Sout according to the outputs of the relative encoder 102 and the absolute encoder 103, but also can calibrate the output error of the absolute encoder 103 according to the output of the relative encoder 102.

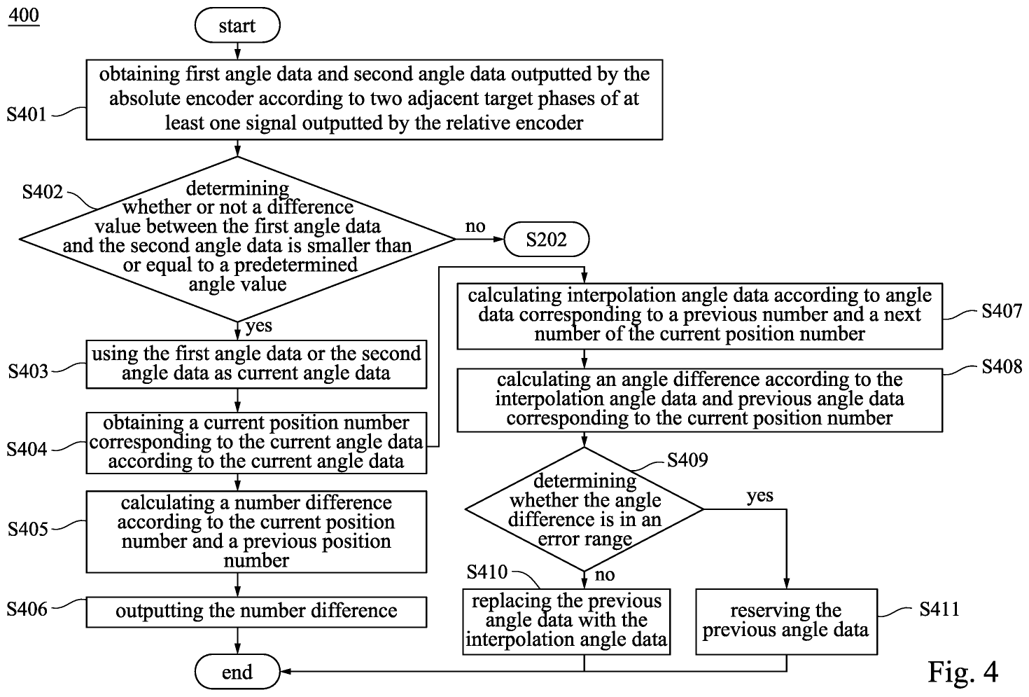

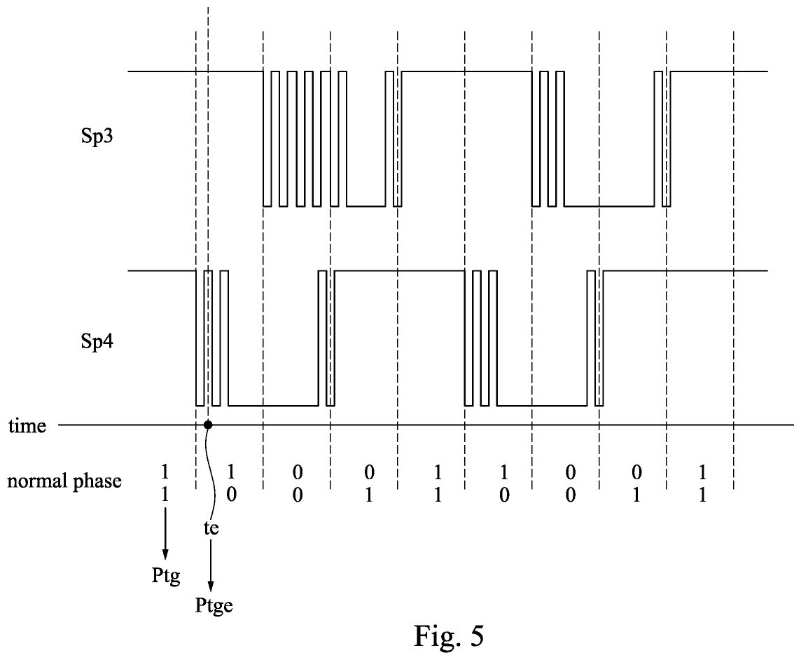

The operation of the input device 10 when the relative encoder 102 might abnormally operate is described below with reference to FIGS. 4 and 5. Referring to FIG. 4, FIG. 4 is a flow diagram of a control method 400 in accordance with some embodiments of the present disclosure. The control method 400 can be executed by the input device 10 of FIG. 1, but the present disclosure is not limited herein. In some embodiments, the control method 400 includes steps S401-S411.

Referring to FIG. 5, FIG. 5 is a schematic diagram of the at least one signal outputted by the relative encoder 102, which abnormally operates, in accordance with some embodiments of the present disclosure. In some embodiments, the at least one signal includes a third signal Sp3 and a fourth signal Sp4. Since the relative device 102 is affected by mechanical damage or dusts, the third signal Sp3 and the fourth signal Sp4 is unable to keep normal waveform (e.g., square wave in FIG. 3). As shown in FIG. 5, at a time point te, the fourth signal Sp4 should keep at low voltage level, but a glitch is occurred. Therefore, before performing step S201, the processor 104 might regard a phase Ptge at the time point te as the target phase, and thereby reading the output of the absolute encoder 103 at the wrong time.

In order to avoid reading the output of the absolute encoder 103 at the wrong time, the processor 104 performs step S401. In step S401, first angle data and second angle data outputted by the absolute encoder are obtained according to two adjacent target phases of at least one signal outputted by the relative encoder. In some embodiments, as shown in FIG. 5, the processor 104 recognizes one correct target phase Ptg and another phase Ptge which is mistakenly recognized as the target phase due to the glitch from the third signal Sp3 and the fourth signal Sp4. Accordingly, the processor 104 reads two rotation angles Sa, which are outputted by the absolute encoder 103, as the first angle data and the second angle data at two time points corresponding to the target phase Ptg and the phase Ptge of FIG. 5.

Since the time difference between two adjacent target phases of the abnormal signal (i.e., the third signal Sp3 and the fourth signal Sp4) might be too small (which might result in that the first angle data and the second angle data are close to each other), the processor 104 then performs step S402. In step S402, it is determined whether or not a difference value between the first angle data and the second angle data is smaller than or equal to a predetermined angle value. For example, the predetermined angle value is 10°. In some embodiments, since the first angle data subtracted from the second angle data is 8.6°, the processor 104 determines that the difference value between the first angle data and the second angle data is smaller than the predetermined angle value, so as to perform step S403. It can be appreciated that if the first angle data subtracted from the second angle data is negative value, the processor 104 can first perform an absolute value calculation on the difference value between the first angle data and the second angle data, and then compare the absolute value of the difference value with the predetermined angle value.

In step S403, the first angle data or the second angle data is used as a current angle data. In some embodiments, the processor 104 uses the second angle data as the current angle data. In other embodiments, the processor 104 uses the first angle data as the current angle data. It can be appreciated that the determination result of step S402 shows that the first angle data and the second angle data are close to each other, so that the first angle data and the second angle data might correspond to the same position number Np in the lookup list. Therefore, the processor 104 can use one of the first angle data and the second angle data as the current angle data.

In step S404, a current position number corresponding to the current angle data is obtained according to the current angle data. In step S405, a number difference is calculated according to the current position number and a previous position number. In step S406, the number difference is outputted. It can be appreciated that the descriptions of steps S404-S406 are same or similar to those of step S202-S204, and therefore are omitted herein.

As shown in FIG. 4 again, after step S404, the processor 104 further performs step S407 to calibrate the output error of the absolute encoder 103 when the relative encoder 102 abnormally operates. In step S407, interpolation angle data is calculated according to angle data corresponding to a previous number and a next number of the current position number. For example, the current position number is the number (4) in the lookup list. The processor 104 can find one angle corresponding to the number (3) and another angle corresponding to the number (5) by the lookup list as shown in Table 1. Then, the processor 104 can perform an interpolation calculation (for example, interpolating by equally dividing or curve fitting) on two angle values Va corresponding to the number (3) and the number (5) to calculate the interpolation angle data.

In step S408, an angle difference is calculated according to the interpolation angle data and a previous angle data corresponding to the current position number. In step S409, it is determined whether the angle difference is in an error range. In step S410, the previous angle data is replaced with the interpolation angle data. In step S411, the previous angle data is reserved. It can be appreciated that the descriptions of steps S408-S411 are same or similar to those of step S205-S208, and therefore are omitted herein. In other embodiments, step S411 is omitted. In other words, after determining the angle difference does not exceed the error range, the processor 104 can perform no operation.

In other embodiments, the determination result of step S402 shows that the difference value between the first angle data and the second angle data is not smaller than or equal to the predetermined angle value, so that the processor 104 can then perform step S202 of the control method 200 of FIG. 2. It can be appreciated that the processor 104 would use the second angle data as the current angle data at this time to perform related operations.

It can be seen from the description of the control method 400 that in the condition that the relative encoder 102 abnormally operates, the input device 10 can still accurately generate the output signal Sout according to the output of the absolute encoder 103. In addition, in comparison to the operation of calibrating the lookup list (i.e., steps S205-S208) in the control method 200, the control method 400 determines whether to calibrate the lookup list or not (i.e., steps S408-S411) according to the interpolation angle data generated in step S407, so as to solve the error problem of the absolute encoder 103.

In the above embodiments, as shown in FIG. 3 or 5, the at least one signal outputted by the relative encoder 102 includes two different signals, but the present disclosure is not limited herein. In other embodiments, the at least one signal outputted by the relative encoder 102 includes one square wave (e.g., the first signal Sp1 or the second signal Sp2) only. In other words, the at least one signal outputted by the relative encoder 102 can include two phases, for example phases “0” and “1”. Other arrangements and operations are same or similar to those of the above embodiments, and therefore the descriptions thereof are omitted herein. Notably, if the relative encoder 102 capable of outputting two signals is damaged and one of the two signals is caused to be abnormal (for example, the first signal Sp1 is normal square wave, while the second signal Sp2 is abnormal signal without a change in voltage level), the input device 10 of the present disclosure can also normally operate based on the normal one of the two signals.

It can be seen from the above embodiments of the present disclosure that the input device 10 of the present disclosure can calibrate the output error of the absolute encoder 103 according to the output of the relative encoder 102 when the relative encoder 102 normally operates, and can generate the output signal Sout according to the output of the absolute encoder 103 when the relative encoder 102 abnormally operates. In addition, when the relative encoder 102 abnormally operates, the input device 10 of the present disclosure can calculate the interpolation angle by the lookup list to calibrate the output error of the absolute encoder 103. In such way, the input device 10 of the present disclosure has the advantages of longer service life and ability to self-calibrate after leaving factory.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A control method of an input device, comprising:
obtaining current angle data outputted by an absolute encoder according to a target phase of at least one signal outputted by a relative encoder;
obtaining a current position number corresponding to the current angle data according to the current angle data;
calculating a number difference according to the current position number and a previous position number; and
outputting the number difference.

2. The control method of claim 1, further comprising:
calculating an angle difference according to the current angle data and previous angle data corresponding to the current position number; and
determining whether the angle difference is in an error range.

3. The control method of claim 2, further comprising:
if the angle difference is in the error range, reserving the previous angle data.

4. The control method of claim 2, further comprising:
if the angle difference is not in the error range, replacing the previous angle data with the current angle data.

5. The control method of claim 1, wherein the at least one signal comprises a first signal and a second signal different from the first signal, and the target phase is that a voltage level of the first signal is same as a voltage level of the second signal.

6. The control method of claim 1, wherein the target phase is that the at least one signal is at a high voltage level or a low voltage level.

7. The control method of claim 1, wherein obtaining the current position number corresponding to the current angle data comprises:
comparing the current angle data with a plurality of angle values to find one of the plurality of angle values closest to the current angle data; and
using one of a plurality of position numbers corresponding to the one of the plurality of angle values closest to the current angle data as the current position number.

8. A control method of an input device, comprising:
obtaining first angle data and second angle data outputted by an absolute encoder according to two adjacent target phases of at least one signal outputted by a relative encoder;
if a difference value between the first angle data and the second angle data is smaller than or equal to a predetermined angle value, using the first angle data or the second angle data as current angle data;
obtaining a current position number corresponding to the current angle data according to the current angle data;
calculating a number difference according to the current position number and a previous position number; and
outputting the number difference.

9. The control method of claim 8, further comprising:
calculating interpolation angle data according to angle data corresponding to a previous number and a next number of the current position number;
calculating an angle difference according to the interpolation angle data and previous angle data corresponding to the current position number; and
determining whether the angle difference is in an error range.

10. The control method of claim 9, further comprising:
if the angle difference is in the error range, reserving the previous angle data.

11. The control method of claim 9, further comprising:
if the angle difference is not in the error range, replacing the previous angle data with the interpolation angle data.

12. An input device coupled to a computer device, wherein the computer device is configured to display a displayed screen, and the input device comprises:
a roller module configured to generate a motion in response to a user operation;
a relative encoder configured to generate at least one signal according to the motion of the roller module;
an absolute encoder configured to output a rotation angle of the roller module with respect to a reference position according to the motion of the roller module; and
a processor configured to execute following steps:
obtaining current angle data outputted by an absolute encoder when the at least one signal is in a target phase;
obtaining a current position number corresponding to the current angle data according to the current angle data;
calculating a number difference according to the current position number and a previous position number; and
outputting the number difference.

13. The input device of claim 12, wherein the processor is further configured to execute following steps:
calculating an angle difference according to the current angle data and previous angle data corresponding to the current position number; and
if the angle difference is not in an error range, replacing the previous angle data with the current angle data.

14. The input device of claim 12, wherein the at least one signal comprises a first signal and a second signal different from the first signal, and the target phase is that a voltage level of the first signal is same as a voltage level of the second signal.

15. The input device of claim 12, wherein the target phase is that the at least one signal is at a high voltage level or a low voltage level.

16. The input device of claim 12, wherein the input device further comprises a storage, the storage is configured to store a lookup list, the lookup list comprises a plurality of angle values and a plurality of position numbers corresponding to the plurality of angle values, and obtaining the current position number corresponding to the current angle data comprises:
comparing the current angle data with the plurality of angle values to find one of the plurality of angle values closest to the current angle data; and
using one of the plurality of position numbers corresponding to the one of the plurality of angle values closest to the current angle data as the current position number.
